(19) United States
(12) Patent Application Publication
(10) Pub. No.: US 2019/0303818 A1
(43) Pub. Date: Oct. 3, 2019

(54) METHODS AND SYSTEMS FOR GENERATING AND MANAGING, AUTOMATING INHERITABLE AND DYNAMIC BUSINESS PROCESSES

(71) Applicant: iManage LLC, Chicago, IL (US)

(72) Inventor: Arvind AGARWAL, Bangalore (IN)

(21) Appl. No.: 16/204,933

(22) Filed: Nov. 29, 2018

Related U.S. Application Data
(60) Provisional application No. 62/593,250, filed on Dec. 1, 2017.

(51) Int. Cl. G06Q 10/06; G06F 17/24; G06F 3/0482

(52) U.S. Cl. CPC G06Q 10/0633; G06Q 10/06316; G06F 3/0483; G06F 3/0482; G06F 17/243

(57) ABSTRACT

In one aspect, a computerized method useful for generating, managing and automating inheritable and dynamic business process workflows includes the step of creating an inherited version of a basal workflow as an inherited workflow. The method includes the step of unlocking a specific artifacts of the basal workflow while locking the non-specific artifact elements of the basal workflow. The method includes the step of providing the locked properties of the basal workflow as a set of properties of the inherited workflow.

### CROSS-REFERENCE TO RELATED APPLICATIONS

This application claims priority to U.S. provisional patent application no. 62/593,250 filed on 1 DEC. 2017. This provisional patent application is hereby incorporated by reference in its entirety.

### BACKGROUND

Large organizations and enterprises often find it difficult to implement processes across the board while allowing each location to have there uniqueness. Additionally, various process-relevant knowledge may be available within the organization (and on the Internet). However, there may be no structured way to implement this process-relevant knowledge. Additionally, there is a need for automation of tasks at a per-user level. Currently, workflows that are generated across organizations or departments, may not capture how an end-user could ease there work by creating personalized automation. Accordingly, methods and systems are desired to include unique location inheritance and process-relevant knowledge when implementing processes within the organization.

### SUMMARY OF THE INVENTION

In one aspect, a computerized method useful for generating, managing and automating inheritable and dynamic business process workflows includes the step of creating an inherited version of a basal workflow as an inherited workflow. The method includes the step of unlocking a specific artifacts of the basal workflow while locking the non-specific artifact elements of the basal workflow. The method includes the step of providing the locked properties of the basal workflow as a set of properties of the inherited workflow.

In another aspect, a computerized method useful for generating and managing, automating inheritable and dynamic business process workflows includes the step of, for each field of a workflow, providing a set of base-types. The method includes the step of determining a set of global definitions for each base type of the set of base-types. Each of global definition of the set of global definition is versioned, such that when a process later overrides the global definition, the global definition is applied as a new version. The method includes the step of creating the workflow from a basal workflow. The method includes the step of, for each item and for each property in an inherited type of each item of the workflow, determining an inheritance setting. The method includes the step of detecting that a change to the global definition is published. The method includes the step of scanning and updating a set of inherited versions of the workflow to a most-recent version of a global definition. The method includes the step of enabling a user to review and select changes prior to the workflow prior to publication.

### BRIEF DESCRIPTION OF THE DRAWINGS

FIG. 1 illustrates an example process for generating workflows, according to some embodiments.

FIG. 2 illustrates an example screen shot of an example task flow inside another task flow, according to some embodiments.

FIG. 3 illustrates an example task form definition screen, Task form designing inside the task.

FIG. 4 illustrates a screen shot that is presented to an executor of task, according to some embodiments.

FIG. 5 illustrates an example process of workflow inheritance, according to some embodiments.

FIG. 6 illustrates an example process for developing inherited workflows, according to some embodiments.

FIG. 7 illustrates a process for workflow/form customization by exception, according to some embodiments.

FIG. 8 illustrates a process for subscribing and applying workflow changes from a plurality of authors, according to some embodiments.

FIG. 9 illustrates a process for applying workflow/task updates obtained from various sources of knowledge digitally available on Internet, according to some embodiments.

FIG. 10 depicts an exemplary computing system that can be configured to perform any one of the processes provided herein.

FIG. 11 is a block diagram of a sample computing environment that can be utilized to implement various embodiments.

The Figures described above are a representative set, and are not an exhaustive with respect to embodying the invention.

### DESCRIPTION

Disclosed are a system, method, and article of method and system for generating and managing, automating inheritable and dynamic business processes. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Natural language processing (NLP) can be the field of computer science concerned with human speech as it is spoken. NLP processes herein can use speech recognition algorithms, natural language understanding algorithms, natural language generation algorithms (e.g. from formal, machine-readable logical forms), connecting language and machine perception algorithms, dialog systems algorithms, or some combination thereof.

Exemplary Systems

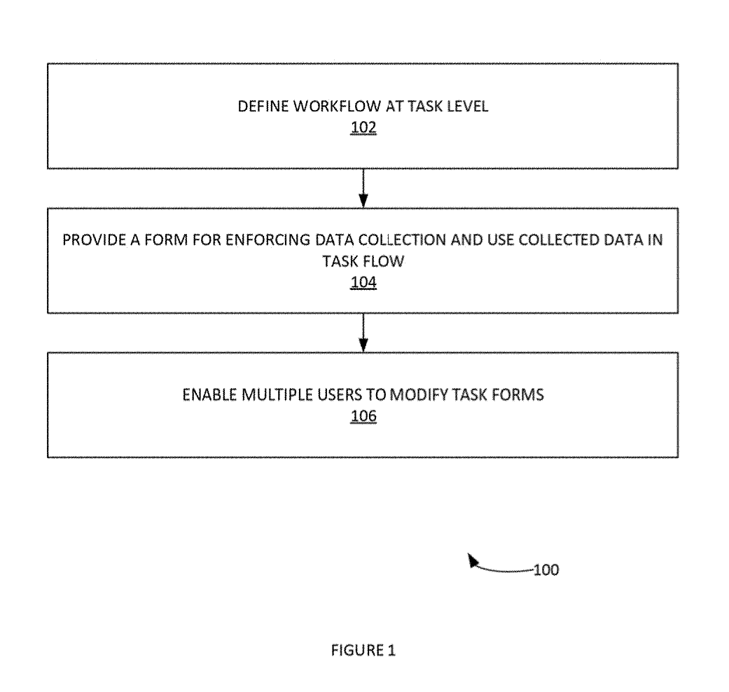

FIG. 1 illustrates an example process 100 for generating workflows, according to some embodiments. In step 102, process 100 can define a workflow at a task level. For example, a user creates a task such as, ‘renovate living room’. The user can then define a set of subtasks that can be available in a task management software. Example subtasks can include, inter alia: create a list of appliances to be placed in room, create a room design, select various furniture, incorporate the furniture in a living room design, remove existing furniture, paint walls a specified color, etc.

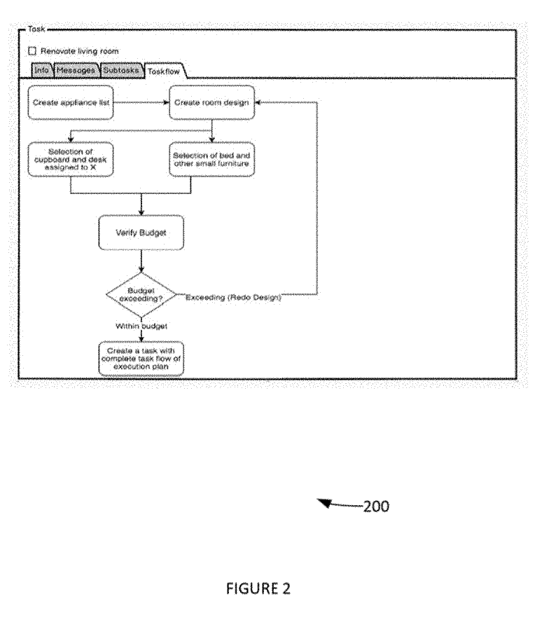

In step 102, it is noted that task level workflows are dynamically created by allowing a workflow to be drawn. FIG. 2 illustrates an example screen shot of an example task flow inside another task flow, according to some embodiments. As shown, the workflow can include other tasks, various system actions (e.g. decisions that involve which path a task can take on a specific condition; other actions such as, inter alia: sending email, calling other software, etc.). This workflow is designed like a flow chart (and/or any other UI to depict similar structure of flow, etc.). The task flows can be dynamically designed for an executing task, modified any time. Or It can be saved as a Task template so that similar tasks can be created any time.

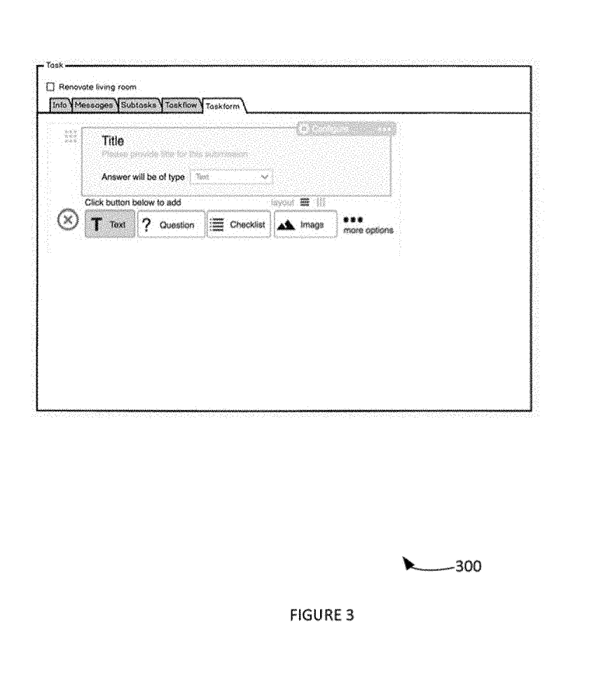

In step 104, process 100 can provide that tasks contain a form for enforcing data collection. Process 100 can use the collected data in the task flows (e.g. task flow created in step 102). The form can be dynamically defined for each task or can be stored in task template. Each task inside a task flow can have its own task flow and form. FIG. 3 illustrates an example Task form definition screen, according to some embodiments. As shown, a task form can be designed inside another task.

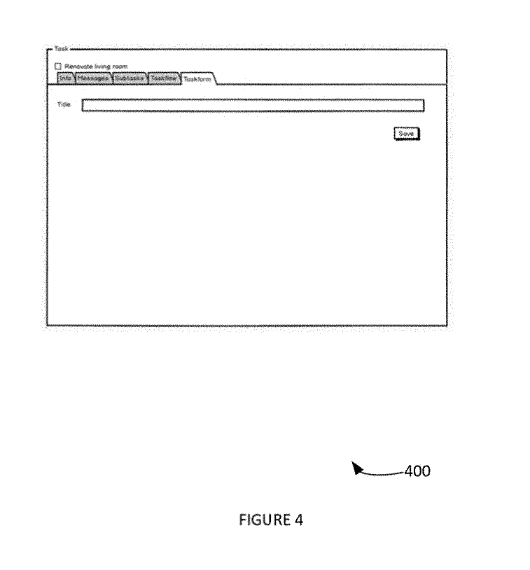

In step 106, process 100 can enable multiple users to modify task forms. It is noted that task form items can be collaborative in nature. Accordingly, multiple users can add items to a task form. Controls/permissions can be enforced as well. For example, only an administrator of the context and user who added the specific elements can edit said elements. In this way, collaborative mandatory items can be added for the actual executor of the task. FIG. 4 illustrates a screen shot that is presented to an executor of task, according to some embodiments.

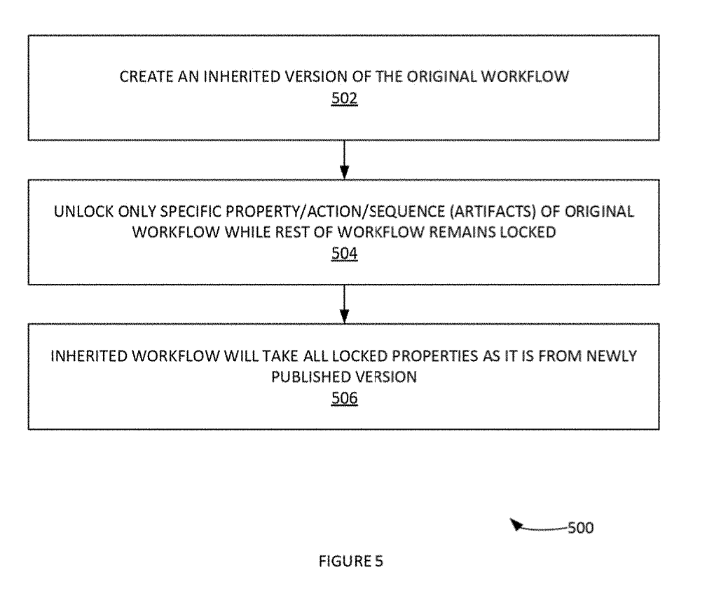

FIG. 5 illustrates an example process 500 of workflow inheritance, according to some embodiments. In step 502, process 500 can create an inherited version of the original workflow. In step 504, process 500 can unlock only specific property/action/sequence (artifacts) of original workflow while rest of workflow remains locked. In step 506, process 500 can inherited workflow will take all locked properties as it is from newly published version. It is noted that, in case a new version of original workflow is published, all locked artifacts can receive the latest data from new version of original workflow while keeping the unlocked items in inherited workflow untouched. Thus retaining the customization.

For example, when shipping workflows an author to a large software audience can enable copying of a workflow as well as further customization/modification of said workflow. This may make it difficult for an original author to publish revisions and provide those revisions to those users while keeping the customizations intact. Similarly, in a large enterprise with many locations, a central administrator may want to develop a workflow, and then enable each location to customize the workflow. But at the same time, the central administrator can be able to publish an overall revision which each location can easily adopt without going through full redesign. Accordingly, to address these issues, process 500 can implement process inheritance and/or customization of a process by exception. Process inheritance can enable a user to customize a workflow and/or form as an inherited version of the original workflow and/or form. This workflow can include the actions, sequences, properties etc. from the original workflow. As noted supra, the inherited process can have some of the original properties/actions/sequences unlocked. The inherited process can enable the modification of values (e.g. while rest of the workflow remains locked). Accordingly, a new version of an original workflow can be published, and the inherited workflow can include all the locked properties as it is from newly published version. However, the unlocked attributes of the workflow can be retained, thus resulting in a new resulting workflow which combines customization on new version of original workflow. It is noted that a similar inheritance model can be applied to forms within workflow where specific fields/properties can be unlocked in inherited workflow and customized.

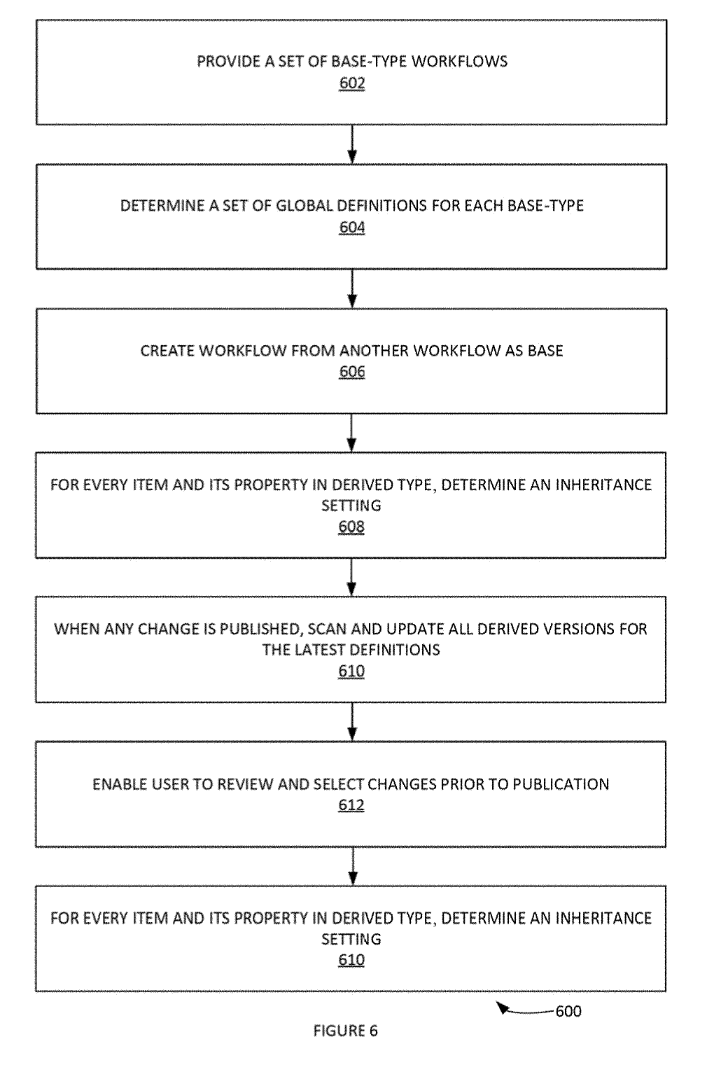

FIG. 6 illustrates an example process 600 for developing inherited workflows, according to some embodiments. In step 602, for each field/workflow, process 600 can provide a set of base-types in the system. Example base-types can include, inter alia: basic task type, basic poll, basic story etc.

In step 604, process 600 can determine a set of global definitions for each base-type. The global definitions can be stored in a database. Each of global definition can be versioned, such that if process 600 later overrides a definition, the definition can be applied as a new version.

In step 606, process 600 can create workflow from another workflow as base. This can be either a base-type of workflow or an inherited-type of workflow. By default, such an inheritance can be from latest published version of a parent-type of workflow. However, it can also be changed to a specific version.

In step 608, for every item and its property in a derived/inherited type, process 600 can determine an inheritance setting. The inheritance setting can be overridden in the derived/inherited type for that specific property. This can be represented with a lock icon, so if property is locked, it is inherited, but if you unlock it, you can edit at that level.

It is noted that initially all changes can remain in draft stage, and not applied to inherited child workflows unless the version is published. An inherited workflow can choose to inherit from an older version. In step 610, when any change is published, process 600 can scan and update all derived/inherited versions for the latest definitions.

In step 612, process 600 can enable a user to review and select changes prior to publication. Although, the original workflow is already published, however the user can be provided a choice to review and select changes they want to apply to the respective inherited workflow. For system upgrades where changes are provided in base system types, process 600 can enable said changes automatically. A user can review the impact of said changes prior to their implementation. The user can select to keep an inheritance from an older version as well. This way users can adopt new base types as their own. Before publishing to changes, the user can review said changes, in terms which inherited types are to be changed due to the publication and then decide if they want to change any of them to prevent the new publish to propagate.

In step 614, for a collection of items (e.g. a checklist, task sequence, etc.), process 600 can provide settings to control inheritance. At a grid level, a user can break inheritance for new rows. This can be set to not allow addition or deletion of new rows from parent. At a row level, a user can break inheritance, and either delete the row entirely (e.g. it can be shown as struck as since it is coming from inherited entity). Alternatively, a user may not want this row to be deleted from parent. Accordingly, the inheritance can control deletion from a parent workflow or at child workflow level using row level flag. At each cell level in row, process 600 can have an inheritance flag. Each row can have a unique identifier, to uniquely identify the row, so that in case rows are changed it does not create an issue. This unique identifier can be set to not be changeable and can be unique across the hierarchy of workflows. For rows created at that level (e.g. a non-inherited level, etc.) a lock icon is not to be shown.

A sequence inheritance example is now discussed. The sequence number can be the index of the array. In one example a state's sequence number and same logic can be used for the collection sequence number. A workflow called A can be provided. Workflow A can have 3 state S1(1), s2(2), s3(3). An inheritance of a workflow called B from A can be provided. Accordingly, B can have state s1(1), s2(2), s3(3). The process can remove s2 and add s4, s5 in between s1 and s3. Now workflow B can have the following state s1(1), s5(2), s4(3), s3(4). An inheritance workflow called C from B can be provided with the state sequence of s1(1), s5(2), s4(3), s3(4). The process can add s6, s7 in between s5 and s4 and add s8, s9 between s4 and s3 such that the sequence is now s1(1), s5(2), s6(3), s7(4), s4(5), s8(6), s9(7), s3(8). The process can remove s3 from B and reorder it as s5(1), s1(2), ds4(3). Workflow C can be used to implemented that following steps: from the parent there can be s5(1), s1(2), s4(3); remaining sequences in inheritance workflow C are s6, s7, s8, s9; starting with s6, in the previous state s6 was after s5, so new sequence s5(1), s6(2), s1(3), s4(4); second is s7 and that is after s6 no new sequence s5(1), s6(2), s7(3), s1(4), s4(5); third is s8 and this after s4 so new sequence s5(1), s6(2), s7(3)s1(4), s4(5), s8(6); fourth is s9 and this is after s8 so new sequence can be s5(1), s6(2), s7(3), s1(4), s4(5), s8(6), s9(7). It is noted that this method of sequence inheritance can be applied to any artifact where sequence inheritance is required.

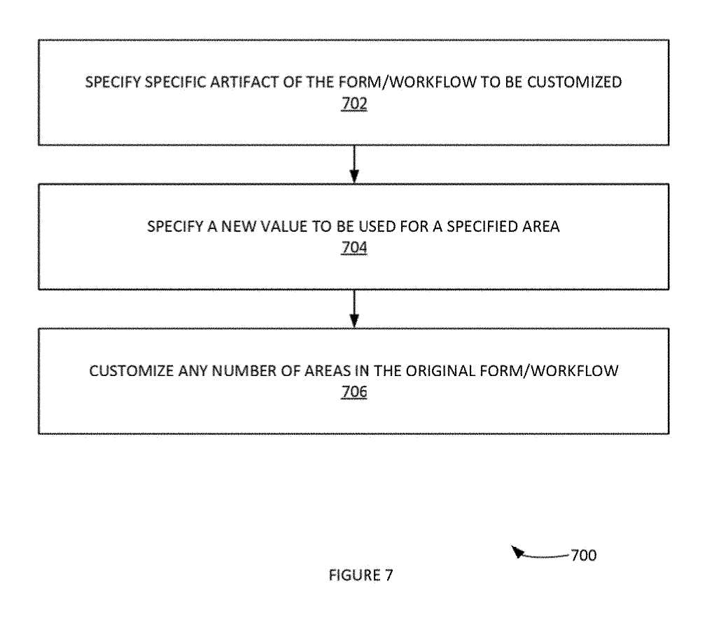

FIG. 7 illustrates a process 700 for workflow/form customization by exception, according to some embodiments. Process 700 can use another model of achieving objectives similar to inheritance is customization by exception. In this model, in step 702, process 700 can enable a user to specify a specific artifact of the form/workflow to be customized. This can be an action, a field, or property of a specific action or field, or say skipping specific action, hiding a field etc. In step 704, a specific area is selected to be customized and process 700 can specify the new value to be used for that area. In step 706, process 700 can customize any number of areas in the original form/workflow. In this way, the original workflow or form is not directly touched, and list of exceptions are maintained very clearly. If the underlying form/workflow definition changes the new effective form/workflow can then be executed based on exceptions on the new underlying form/workflow.

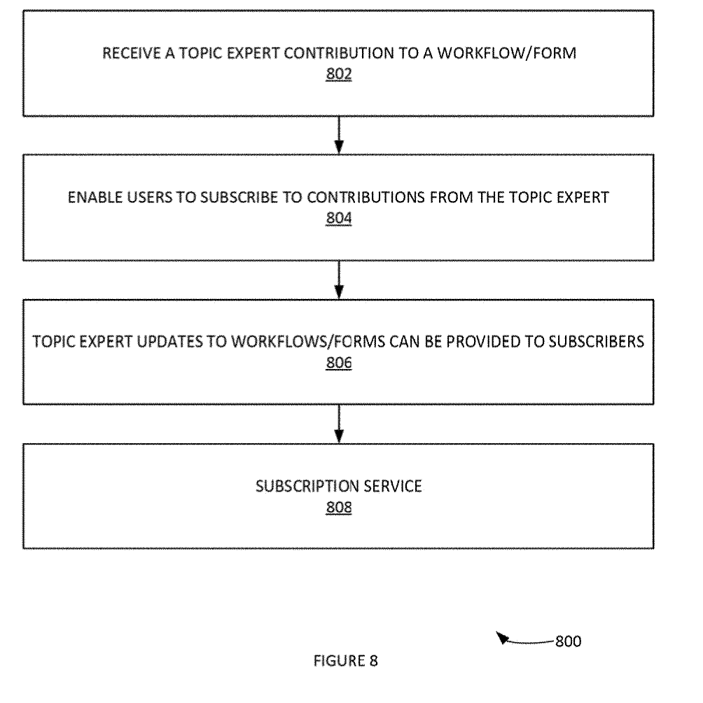

FIG. 8 illustrates a process 800 for subscribing and applying workflow changes from a plurality of authors, according to some embodiments. In one example, there may be a plurality of authors (e.g. topic experts, etc.). In step 802, process 800 can receive a topic expert contribution to a workflow/form. A topic expert can have knowledge of a specific process. A topic expert may wish to use that knowledge to contribute within a specified workflow/form. In step 804, process 800 can enable users to subscribe to contributions from the topic expert. For example, users can subscribe to specified author/experts, and see new workflows whenever proposed by these author/experts. This can provide a user an opportunity to implement those workflows in their businesses or environment.

Process 800 can provide subscribers an changes to the specified workflow/form by an expert. Accordingly, users can see these granular changes, and selectively decide on applying these changes to their workflows. It is noted that user may be subscribing to multiple authors since as an end user one gets to learn from multiple experts and implement those best practices published by such experts. In step 806, topic expert updates to workflows/forms can be provided to subscribers.

In one example, process 800 can be implemented in a digital marketing space, such as a search engine optimization (SEO) process. Multiple experts can provide various SEO-related workflows and/or best practices. A user can subscribe to these various experts and receive the SEO-related workflows and/or best practices when published by the experts.

Two approaches can be used for applying the changes of an expert to user's workflow. If the user's workflow was originally derived from the expert's workflow, then the user's workflow can be inherited and/or have references to the expert's original workflow template (e.g. by reference to the expert's workflow template). In case of another expert, another expert (e.g. other than the expert associated with the originally inherited workflow) can publish a set of changes. In such a case, since there is no inheritance relationship and no reference from the workflow it would become tedious for user to select exact target area where the changes are to be applied, accordingly, process 800 can provide/implement a namespace. Each action of a workflow and/or section in a form can be tagged with a namespace. Any expert workflow published can be determined to comply with a set of namespace guidelines set forth by an administrative entity.

Users can start a workflow from an expert workflow. The expert workflow can include a set of approved namespaces. Whenever a new update is published by any expert, any associated namespace can be used to determine a target for applying that update. In the case when a user has no such namespace then the user can manually select an area within workflow where change is to be applied. The namespace can be copied to a specified area and similar future changes applied easily in artifacts containing this namespace I. In one example, each action/form section can contain multiple namespaces, although normally they might have just one namespace. A namespace can be set as more granular by an author or can be broader than desired by the end user and can have multiple activities with a same namespace. One activity can have a plurality of namespaces.

Continuning with SEO Process example, Project administrator can subscribe at SEO level, keyword research level and/or a synonyms level. Namespace can be associated at workflow/task/checklist item. Anyone giving public template can provide a namespace. Process 800 can provide an interface to sanitize namespaces given by authors/experts. A user can merge into an existing namespace. Namespaces can be set a mergeable or non-mergeable.

Process 800 can provide that user pay to participate in a subscription model in step 808. The paid model can be one-time subscription or recurring model. Users can subscribe to specific namespaces. In one example, by default, a user can be subscribed to all public experts/namespaces. Users can choose to change the subscription preferences. User can decide to follow specific experts and/or choose to unfollow some. User can choose to unsubscribe all experts as well. When publishing updates, an expert can provide a higher-level description of update also so that users can understand the update in more depth and then apply.

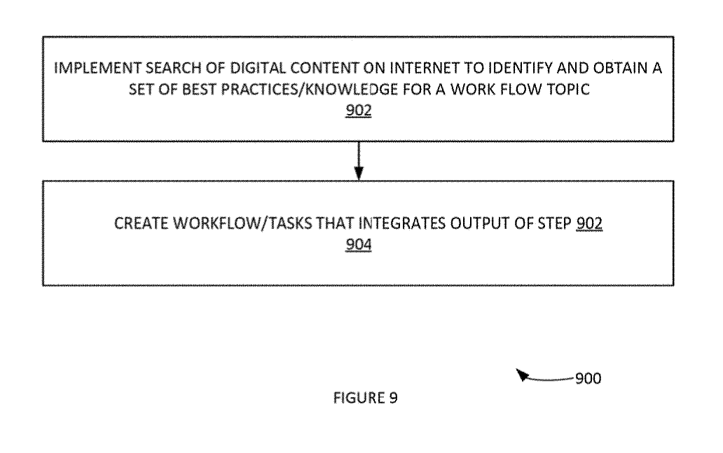

FIG. 9 illustrates a process 900 for applying workflow/task updates obtained from various sources of knowledge digitally available on Internet, according to some embodiments. These sources can be, inter alia, blogs, microblogs, social networking posts, transcripts of online videos, etc. These digital sources can be sources of best practices of various topics. Accordingly, in step 902, process 900 can implement a search of digital content on internet to identify and obtain a set of best practices/knowledge for a work flow topic. This digital content can be identified, indexed and/or downloaded.

In step 904, process 900 can create workflow/tasks that integrates output of step 902. For example, process 900 can create workflow/tasks from these best practices or knowledge which can be applied to specific workflow (using namespaces) so that the blog (and/or another source) can be converted to something actionable. For example, a user can integrate these actions inside their workflows. These tasks can have namespaces for an exact target for applying the task. Some tasks can be plain task with recurrence frequency. And can be manually added as one-time task/recurring task or task within an existing workflow. Process 900 can also have an automated way of extracting tasks from few blogs using various artificial intelligence (Al) techniques. For example, a blog (and/or other source of content) can be parsed using NLP, understanding the context and action desired and propose set of tasks.

Example Computing Systems

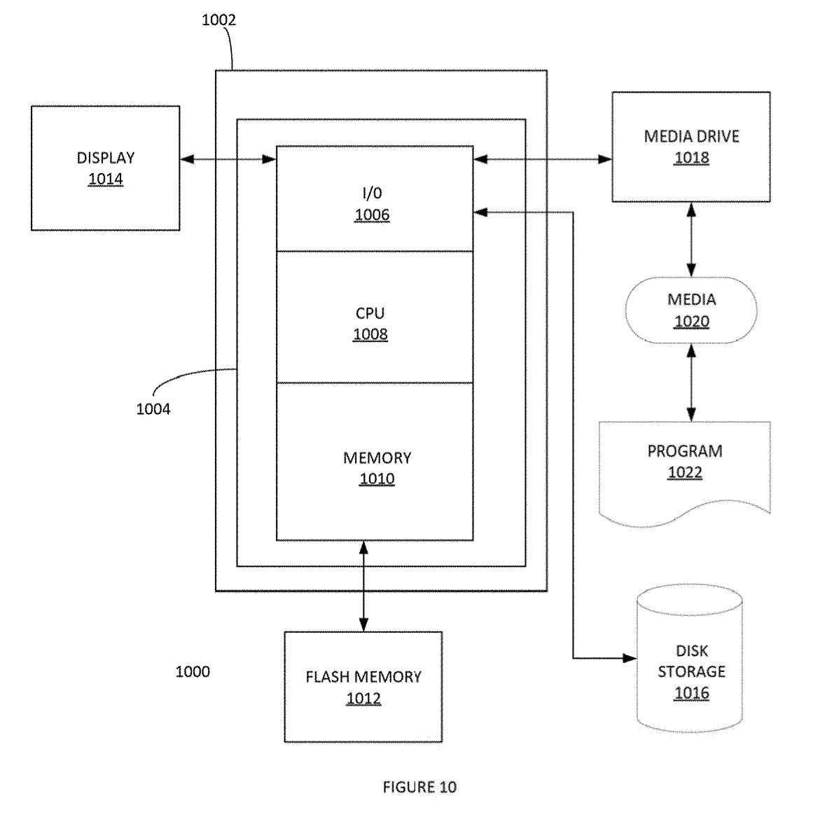

FIG. 10 depicts an exemplary computing system 1000 that can be configured to perform any one of the processes provided herein. In this context, computing system 1000 may include, for example, a processor, memory, storage, and I/O devices (e.g., monitor, keyboard, disk drive, Internet connection, etc.). However, computing system 1000 may include circuitry or other specialized hardware for carrying out some or all aspects of the processes. In some operational settings, computing system 1000 may be configured as a system that includes one or more units, each of which is configured to carry out some aspects of the processes either in software, hardware, or some combination thereof.

FIG. 10 depicts computing system 1000 with a number of components that may be used to perform any of the processes described herein. The main system 1002 includes a motherboard 1004 having an I/O section 1006, one or more central processing units (CPU) 1008, and a memory section 1010, which may have a flash memory card 1012 related to it. The I/O section 1006 can be connected to a display 1014, a keyboard and/or other user input (not shown), a disk storage unit 1016, and a media drive unit 1018. The media drive unit 1018 can read/write a computer-readable medium 1020, which can contain programs 1022 and/or data. Computing system 1000 can include a web browser. Moreover, it is noted that computing system 1000 can be configured to include additional systems in order to fulfill various functionalities. Computing system 1000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

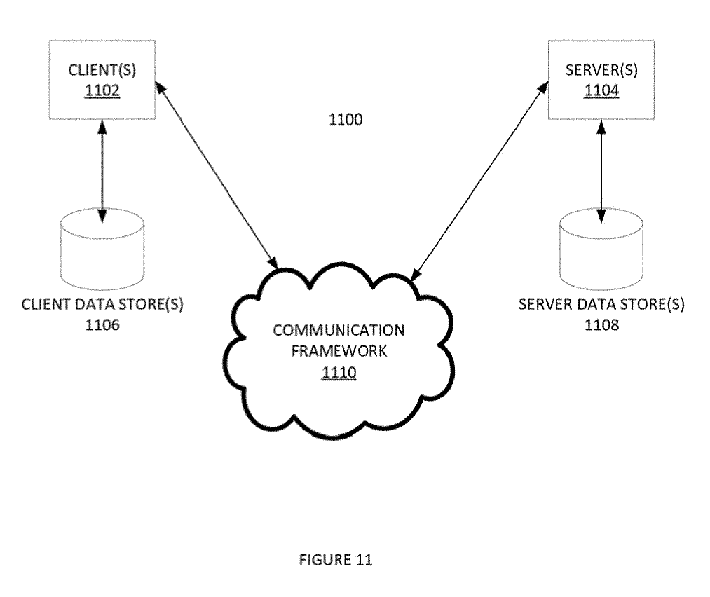

FIG. 11 is a block diagram of a sample computing environment 1100 that can be utilized to implement various embodiments. The system 1100 further illustrates a system that includes one or more client(s) 1102. The client(s) 1102 can be hardware and/or software (e.g., threads, processes, computing devices). The system 1100 also includes one or more server(s) 1104. The server(s) 1104 can also be hardware and/or software (e.g., threads, processes, computing devices). One possible communication between a client 1102 and a server 1104 may be in the form of a data packet adapted to be transmitted between two or more computer processes. The system 1100 includes a communication framework 1110 that can be employed to facilitate communications between the client(s) 1102 and the server(s) 1104. The client(s) 1102 are connected to one or more client data store(s) 1106 that can be employed to store information local to the client(s) 1102. Similarly, the server(s) 1104 are connected to one or more server data store(s) 1108 that can be employed to store information local to the server(s) 1104. In some embodiments, system 1100 can instead be a collection of remote computing services constituting a cloud-computing platform.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for generating, managing and automating inheritable and dynamic business process workflows comprising:
creating an inherited version of a basal workflow as an inherited workflow;
unlocking a specific artifacts of the basal workflow while locking the non-specific artifact elements of the basal workflow; and
providing the locked properties of the basal workflow as a set of properties of the inherited workflow.

2. A computerized method useful for generating and managing, automating inheritable and dynamic business process workflows comprising:
for each field of a workflow, providing a set of base-types;
determining a set of global definitions for each base type of the set of base-types, wherein each of global definition of the set of global definition is versioned, such that when a process later overrides the global definition, the global definition is applied as a new version;
creating the workflow from a basal workflow;
for each item and for each property in an inherited type of each item of the workflow, determining an inheritance setting;
detecting that a change to the global definition is published;
scanning and updating a set of inherited versions of the workflow to a most-recent version of a global definition; and
enabling a user to review and select changes prior to the workflow prior to publication.

3. The computerized method of claim 2, wherein a base type comprises a basic task type, basic poll, or a basic story.

4. The computerized method of claim 3, wherein the basal workflow comprises a base-type of workflow or an inherited-type of workflow.

5. The computerized method of claim 3, wherein by default, an inheritance from the the basal workflow is from a last published version of a parent-type of workflow.

6. The computerized method of claim 3, wherein the inheritance setting is overridden in the inherited type for a specific property.

7. The computerize method of claim 6 further comprising:
providing the user a choice to review and select changes to apply to the respective inherited workflow, and
for a set of system upgrades where changes are provided in base system types, automatically enabling a set of changes.

8. The computerized method of claim 7, wherein a user specifies a specific artifact of the workflow to be customized.

9. The computerized method of claim 8, wherein the specific artifact to be customized comprises a specified number of areas in the basal workflow.

10. A computerized system useful for generating and managing, automating inheritable and dynamic business process workflows comprising:
at least one processor configured to execute instructions;
at least one memory containing instructions when executed on the at least one processor, causes the at least one processor to perform operations that:
for each field of a workflow, provide a set of base-types;
determine a set of global definitions for each base type of the set of base-types, wherein each of global definition of the set of global definition is versioned, such that when a process later overrides the global definition, the global definition is applied as a new version;
create the workflow from a basal workflow;
for each item and for each property in an inherited type of each item of the workflow, determine an inheritance setting;
detect that a change to the global definition is published;
scan and update a set of inherited versions of the workflow to a most-recent version of a global definition; and
enablea user to review and select changes prior to the workflow prior to publication.

11. The computerized system of claim 10, wherein a base type comprises a basic task type, basic poll, or a basic story.

12. The computerized system of claim 11, wherein the basal workflow comprises a base-type of workflow or an inherited-type of workflow.

13. The computerized system of claim 12, wherein by default, an inheritance from the the basal workflow is from a last published version of a parent-type of workflow.

14. The computerized system of claim 13, wherein the inheritance setting is overridden in the inherited type for a specific property.

15. The computerize system of claim 14, wherein the at least one memory containing instructions when executed on the at least one processor, causes the at least one processor to perform operations that:
provides the user a choice to review and select changes to apply to the respective inherited workflow, and for a set of system upgrades where changes are provided in base system types, automatically enabling a set of changes.

16. The computerized system of claim 15, wherein a user specifies a specific artifact of the workflow to be customized.

17. The computerized system of claim 16, wherein the specific artifact to be customized comprises a specified number of areas in the basal workflow.
